(19) United States
(12) Patent Application Publication
(10) Pub. No.: US 2003/0051675 A1
(43) Pub. Date: Mar. 20, 2003

(54) Growth inhibitor

(76) Inventors: Reginald Joseph Henley, Hampshire (GB); Ann Henley, Hampshire (GB); Clair Nikola Henley, Hampshire (GB)

Correspondence Address: Anthony A Laurentano, Lahive & Cockfield, 28 State Street, Boston, MA, 02109, US

(21) Appl. No.: 10/181,017

(22) PCT Filed: Jan. 2, 2001
(86) PCT No.: PCT/GB01/00005

(30) Foreign Application Priority Data
Jan. 15, 2000 (GB) 0000829.2

(51) Int. Cl. A01K 63/04; A01K 61/00

(52) U.S. Cl. 119/231

(57) ABSTRACT

A growth inhibitor comprising a porous container 2A, 2B, housing a non-resinous wood charcoal 5, such as a hardwood charcoal. The container may further contain hydrous silicates and/or granite chips.

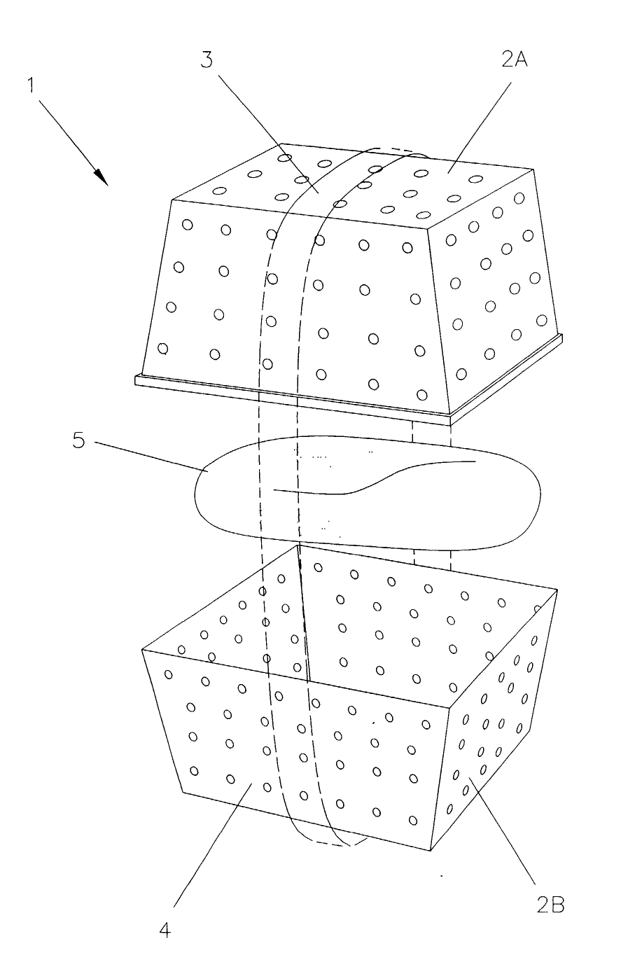

The present invention relates to a growth inhibitor for use in water, particularly for use in reducing growth of algae in ponds such as garden ponds.

Many people create ornamental ponds in their gardens to grow water plants such as lilies and/or to stock fish such as goldfish. The presence of CO₂ and Nitrogen (often generated by ammonia) in the water is converted into algae in the presence of sunlight. The algae reduces the clarity in the water thus preventing plants and/or fish from being seen clearly. Also ammonia present in the water is toxic to fish.

It has been proposed in, for example, Patent Abstracts of Japan vol 1997 no.03, and vol 1996, no 12, to use charcoal in treating water, and in Patent Abstracts of Japan, vol 017, no.627, is disclosed the use of charcoal and hydrous silicates. These proposals do not, however, address the problem of hard water as is commonly encountered in garden ponds.

The invention seeks to provide a solution to this problem.

According to the present invention there is provided a growth inhibitor comprising a porous container housing a non-resinous wood charcoal and hydrous silicates, and characterised in that the container also includes granite chips, the charcoal, granite chips and hydrous silicates being in a weight ratio of 7:11:0.02. respectively.

Preferably the charcoal and hydrous silicates and/or granite chips are in granular form, preferably in a particle size of 6-10 mm, and the container may include an inner container of a porous mesh such as a nylon mesh inside an outer container housing with apertures therein. The outer container housing may be formed from a pair of planting baskets.

An embodiment of the invention will now be described, by way of example, with reference to the accompanying drawing which showing a perspective exploded view of a growth inhibitor according to the present invention.

Referring to the drawing there is shown a growth inhibitor 1 having an outer container housing formed from a pair of planting baskets 2A,2B joined together by a strap 3. Each basket has a number of apertures 4 in its walls to make the outer container housing porous.

Inside the outer container housing is an inner container in the form of a porous nylon mesh bag 5. Bag 5 houses a granular mixture of hardwood charcoal, granite chips, and hydrous silicate rock (e.g. as sold under the trade mark Zeolite). Each ingredient has a particle size of 6-10 mm. The charcoal, granite chips and hydrous silicates is in a weight ratio of 7:11:0.02 respectively.

In use, the inhibitor 1 may be placed in a pond to prevent the build up of algae. The water in the pond passes through the apertures in the inner and outer containers. The charcoal absorbs the CO₂ and Nitrogen. The granular chips provide a ballast to the granular mixture to prevent it from floating and slowly leaches acid to neutralise or soften the water in the pond which is often derived from hard tap water. The hydrous silicates absorb ammonia which reduces the Nitrogen content in the water. Ammonia is also harmful to fish so its absorption is of additional benefit if fish are present in the pond.

The outer container may be used as a pedestal to place objects on in the pond.

The performance of the inhibitor of the invention may be improved if water in the pond is circulated through it, e.g. by placing the inhibitor by a water pump inlet or outlet.

It is envisaged that the outer container could be sold as a permanent fixture in a pond, with the granular mixture in the bag sold as a refill for replacement every few months or each year.

The invention may take a form different to that specifically described above, for example the container may be one unit rather than an inner and outer container. Also the granite chips and/or hydrous silicates could be omitted.

Further modifications will be apparent to those skilled in the art without departing from the scope of the present invention.

1. A growth inhibitor comprising a porous container housing a non-resinous wood charcoal and hydrous silicates, and characterised in that the container also includes granite chips, the charcoal, granite chips and hydrous silicates being in a weight ratio of 7:11:0.02. respectively.

2. A growth inhibitor as claimed in claim 1, characterised in that the charcoal is a hardwood charcoal.

3. A growth inhibitor as claimed in claim 1 or claim 2, characterised in that the charcoal and hydrous silicate and/or granite chips are in granular form, preferably in a particle size of 6-10 mm.

4. A growth inhibitor as claimed in any preceding claim, characterised in that the container includes an inner container of a porous mesh such as a nylon mesh inside an outer container housing with apertures therein.

5. A growth inhibitor as claimed in claim 4, characterised in that the outer container housing is formed from a pair of planting baskets.
